(19) United States
(12) Patent Application Publication
(10) Pub. No.: US 2006/0002376 A1
(43) Pub. Date: Jan. 5, 2006

(54) Telephone exchange and network telephone system

(76) Inventors: Ryo Araki, Tokyo (JP); Hiromune Suetsugu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,679

(22) Filed: Jun. 30, 2005

(30) Foreign Application Priority Data
Jun. 30, 2004 (JP) 2004-194935

(51) Int. Cl. H04L 12/66

(52) U.S. Cl. 370/352

(57) ABSTRACT

A telephone exchange connects a plurality of telephone terminals through a communication network that transmits voice packet, and allows the plurality of telephone terminals to communicate with each other. The telephone exchange includes: a storage unit, a controller, and a transfer unit. The storage unit stores a group table representing a correspondence between a plurality of extension groups into which the telephone terminals are classified and the telephone terminals belonging to the extension groups. The controller, when a connection request to one of the extension groups occurs, refers to the group table and performs connection control for the telephone terminals in the corresponding extension group. The transfer unit transfers voice packets sent from the requester to all of the telephone terminals that belongs to the corresponding extension group through the communication network.

### RELATED APPLICATIONS

The present disclosure relates to the subject matter contained in Japanese Patent Application No. 2004-194935 filed on Jun. 30, 2004, which is incorporated herein by reference in its entirety.

### BACKGROUND OF The INVENTION

1. Field of the Invention

The present invention relates to a telephone exchange and a network telephone system that provides additional service such as a group paging function, for a plurality of telephone terminals on a packet network in an IP (Internet Protocol) telephone system.

2. Description of the Related Art

In recent years, a network telephone system (IP telephone system) for transmitting and receiving an image and voice as packet data bidirectionally in real time through a packet network has begun to become widespread.

In the IP telephone system, for example, IP telephone terminals are connected to a LAN (Local Area Network), the LAN is connected to a general subscriber telephone network such as a public switched telephone network through a gateway and the Internet, and protocol conversion and data format conversion are performed in the IP telephone terminal and the gateway, whereby voice communications are made possible between the IP telephone terminals and between the IP telephone terminal and the general subscriber telephone network or the Internet.

In the described system, the group paging function executed in a communication system with a plurality of telephone terminals connected to a private branch exchange is under consideration. (For example, refer to JP-A-5-014256.) The group paging function is a function of distributing a voice signal from a telephone terminal accommodated in one private branch exchange to units of telephone terminals or loudspeakers, and paging (calling) simultaneously. In this case, using hardware such as a time switch or any other distributing apparatus, the voice signal from the calling telephone terminal is distributed to a plurality of called telephone terminals.

### SUMMARY OF THE INVENTION

However, to apply the group paging function to the IP telephone system, the voice signal needs to be passed through the time switch and thus conversion processing between the voice signal and IP packet becomes necessary. Thus, the following problems occur:

(1) Since the conversion processing between the voice signal and IP packet is processing performed in a private branch exchange, processing load on the private branch exchange increases.

(2) As many media gateways for performing conversion between the voice signal and IP packet as the number of terminals to which the voice signal is distributed become necessary, increasing the cost.

(3) The number of destinations to which the voice signal is distributed is limited in the time switch. Thus, to distribute the voice signal to the destinations beyond the limited number of destinations, it is necessary to provide an additional time switch, increasing the cost.

The present invention provides a telephone exchange and a network telephone system that provides the group paging function effectively regardless of the number of terminals to which a voice packet is to be distributed.

According to a first aspect of the invention, there is provided a telephone exchange that connects a plurality of telephone terminals through a communication network that transmits voice packet, and allows the plurality of telephone terminals to communicate with each other, the telephone exchange including: a storage unit that stores a group table representing a correspondence between a plurality of extension groups into which the telephone terminals are classified and the telephone terminals belonging to the extension groups; a controller that, when a connection request to one of the extension groups occurs, refers to the group table and performs connection control for the telephone terminals in the corresponding extension group; and a transfer unit that transfers voice packets sent from the requester to all of the telephone terminals that belongs to the corresponding extension group through the communication network.

According to a second aspect of the invention, there is provided a network telephone system including: a telephone exchange that connects a plurality of telephone terminals through a communication network that transmits voice packet, and allows the plurality of telephone terminals to communicate with each other; and a server that is connected to the communication network, wherein the terminal exchange includes: a storage unit that stores a group table representing a correspondence between a plurality of extension groups into which the telephone terminals are classified and the telephone terminals belonging to the extension groups; and a transfer unit that, when a connection request to one of the extension groups occurs, refers to the group table and transfers information representing the corresponding extension group to the server, wherein the server includes: a controller that performs connection control for the telephone terminals in the corresponding extension group based on the information representing the corresponding extension group sent from the telephone exchange; and a distribution unit that distributes voice packets sent from the requester to all of the telephone terminals that belongs to the corresponding extension group through the communication network.

According to a third aspect of the invention, there is provided a telephone exchange that connects a plurality of telephone terminals through a communication network that transmits voice packet, and allows the plurality of telephone terminals to communicate with each other, the telephone exchange including: a storage means for storing a group table representing a correspondence between a plurality of extension groups into which the telephone terminals are classified and the telephone terminals belonging to the extension groups; a control means for, when a connection request to one of the extension groups occurs, referring to the group table and performing connection control for the telephone terminals in the corresponding extension group; and a transfer means for transferring voice packets sent from the requester to all of the telephone terminals that belongs to the corresponding extension group through the communication network.

### BRIEF DESCRIPTION OF The DRAWINGS

In the accompanying drawings:

FIG. 1 is a drawing to show the schematic configuration of a network telephone system according to a first embodiment of the invention;

FIG. 2 is a block diagram to show a functional configuration of a gateway in the first embodiment;

FIG. 3 is a drawing to show an example of a storage content of an extension group table of the gateway in the first embodiment;

FIG. 4 is a drawing to describe a group paging function operation in the first embodiment;

FIG. 5 is a drawing to show the schematic configuration of a network telephone system according to a second embodiment of the invention;

FIG. 6 is a block diagram to show a functional configuration of a gateway in the second embodiment;

FIG. 7 is a block diagram to show the functional configuration of a distribution server in the second embodiment;

FIG. 8 is a drawing to show a structure of group paging request information;

FIG. 9 is a drawing to show a structure of group setup information;

FIG. 10 is a drawing to describe a group paging function operation in the second embodiment;

FIG. 11 is a flowchart to show control processing of the gateway in executing the group paging function in the second embodiment; and

FIG. 12 is a sequence chart to show the distribution operation of an IP packet in a third embodiment of the invention.

### DETAILED DESCRIPTION OF THE EMBODIMENT

Hereinafter, embodiments of the invention will be described by reference to the drawings in detail.

### First Embodiment

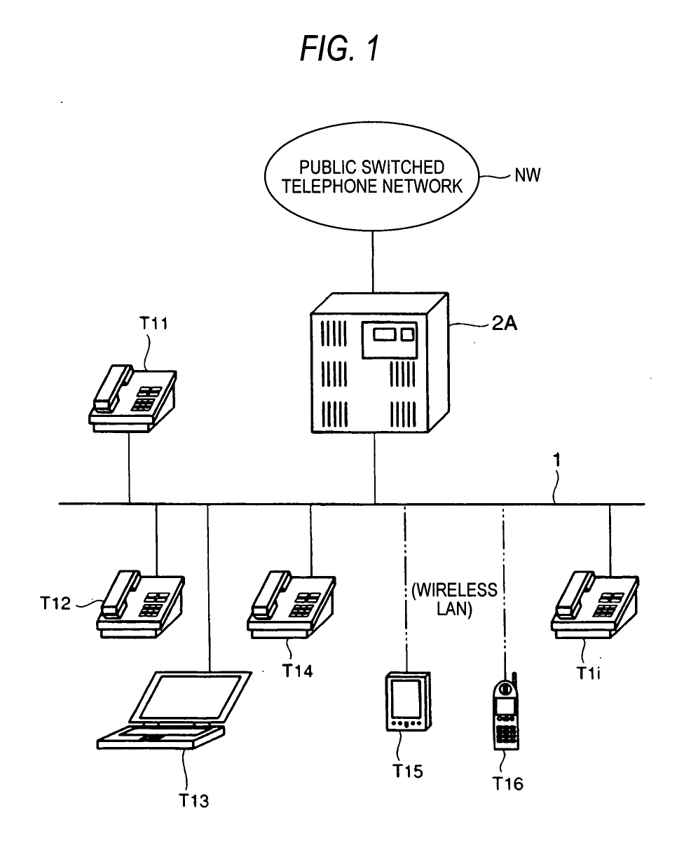

FIG. 1 is a drawing to show the schematic configuration of a network telephone system according to a first embodiment.

The system has a LAN (Local Area Network) 1. A plurality of telephone terminals T11 to T1i (where i is a natural number) are connected to the LAN 1. Each of the telephone terminals T11 to T1i may be configured as any one of: an IP telephone having a conversation processing function and a media information processing function; a personal computer; and a mobile telephone or a portable information terminal having a voice communication function and a wireless LAN access function.

A gateway (telephone exchange) 2A is also connected to the LAN 1. The gateway 2A connects the telephone terminals T11 to T1i connected on the LAN 1 and the telephone terminals T11 to T1i and a public switched telephone network NW.

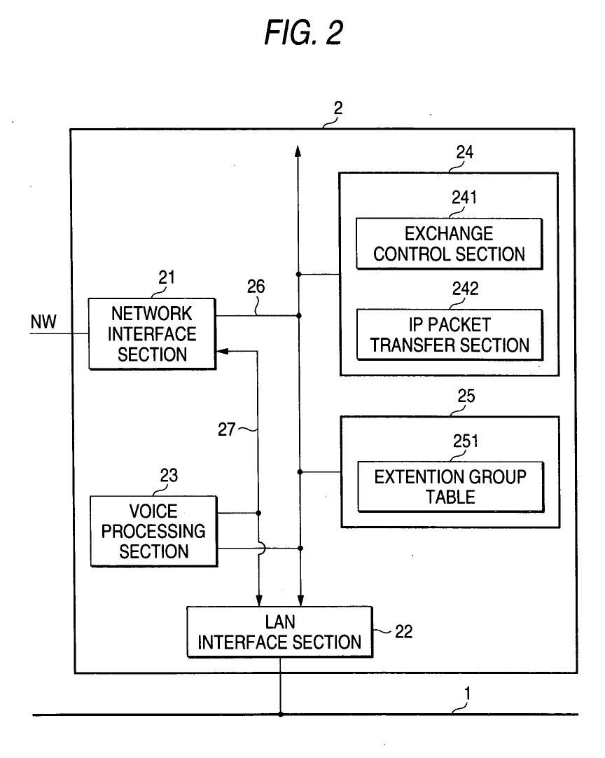

The gateway 2A has functions described below. FIG. 2 is a block diagram to show the configuration of the gateway 2A.

The gateway 2A includes a network interface (I/F) section 21, a LAN interface (I/F) section 22, a voice processing section 23, a control section 24A, and a storage section 25. The network interface section 21, the LAN interface section 22, the voice processing section 23, the control section 24A, and the storage section 25 are connected to each other via a data highway 26.

The network interface section 21, the LAN interface section 22, and the voice processing section 23 are connected to each other via a PCM highway 27.

The public switched telephone network NW is connected to the network interface section 21 as needed. The network interface section 21 performs interface processing between the connected public switched telephone network NW and the PCM highway 27. The network interface section 21 transfers various pieces of control information relating to the interface processing to and from the control section 24A via the data highway 26.

The LAN 1 is connected to the LAN interface section 22 as needed. The LAN interface section 22 performs interface processing between the connected LAN 1 and the PCM highway 27. The LAN interface section 22 transfers various pieces of control information relating to the interface processing to and from the control section 24A via the data highway 26.

The voice processing section 23 has a function of converting a voice packet received from the LAN 1 into a voice signal that can be handled with the public switched telephone network NW and transmitting the voice signal to the public switched telephone network NW.

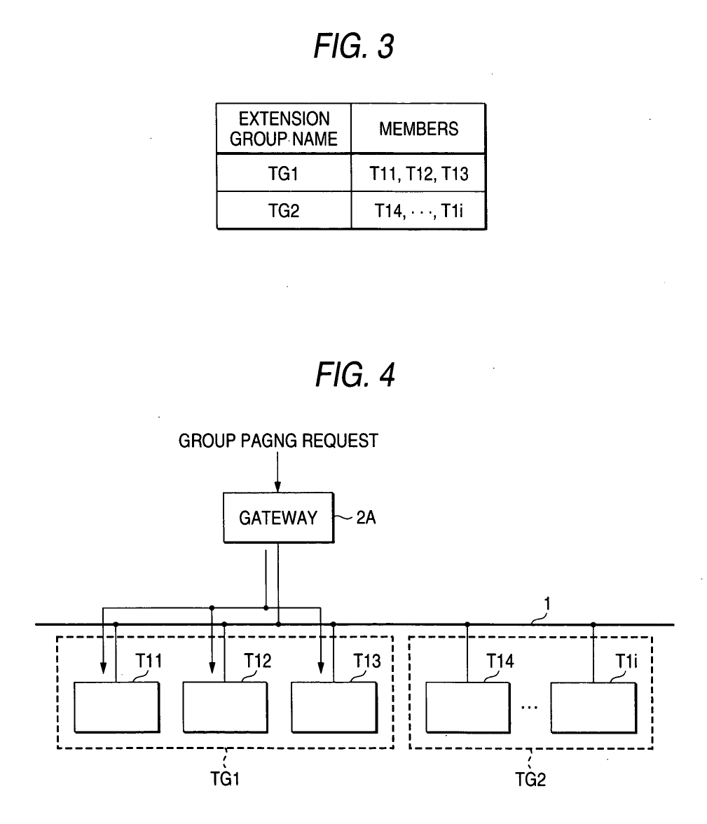

The storage section 25 stores routing information required for connection control of the control section 24A and further stores an extension group table 251. The extension group table 251 stores the correspondence between extension groups TG1 and TG2 into which the telephone terminals T11 to T1i are classified and the telephone terminals T11 to T1i belonging to the extension groups TG1 and TG2, for example, as shown in FIG. 3.

The control section 24A includes an exchange control section 241 and an IP packet transfer section 242.

When a group paging request for one of the extension groups comes, the exchange control section 241 references the extension group table 251 and performs incoming control for the corresponding extension group TG1 or TG2.

At the connection time to the extension group TG1, TG2, the IP packet transfer section 242 distributes the IP packet sent from the requester to the telephone terminals T11, T12, and T13 of the corresponding extension group TG1, for example, through the LAN 1.

The operation of the network telephone system is described below.

Now, assume that a group paging request signal for the extension group TG1 arrives at the gateway 2A from the public switched telephone network NW, as shown in FIG. 4. The gateway 2A transfers incoming data to each of the telephone terminals T11, T12, and T13 belonging to the extension group TG1 based on the storage contents of the extension group table 251 for making an incoming call notification.

When the user of each of the telephone terminals T11, T12, and T13 responds to the incoming call notification, a communication path is formed between the calling external telephone terminal and the called telephone terminal T11, T12, T13, for conducting voice communications therebetween.

That is, the voice signal transmitted from the external telephone terminal is transmitted to the gateway 2A through the public switched telephone network NW. The gateway 2A converts the received voice signal into an IP packet and transmits the IP packet to the telephone terminals T11, T12, and T13 through the LAN 1. In the telephone terminals T11, T12, and T13 receiving the IP packet, voice data is extracted from the IP packet and is converted into an analog voice signal, which is then supplied to the loudspeaker over which voice is output.

As described above, in the first embodiment, when a group paging request signal for the extension group TG1 arrives at the gateway 2A, the gateway 2A references the storage contents of the extension group table 251 and performs incoming control for the extension group TG1 and distributes the IP packet of the calling party to the telephone terminals T11, T12, and T13 of the extension group TG1 through the LAN 1 by software processing.

Therefore, it becomes unnecessary to provide not only an additional time switch, but also as many voice signal—IP packet conversion facilities as the number of terminals to which the IP packet (voice signal) is distributed, so that the processing load on the gateway 2A can be decreased.

### Second Embodiment

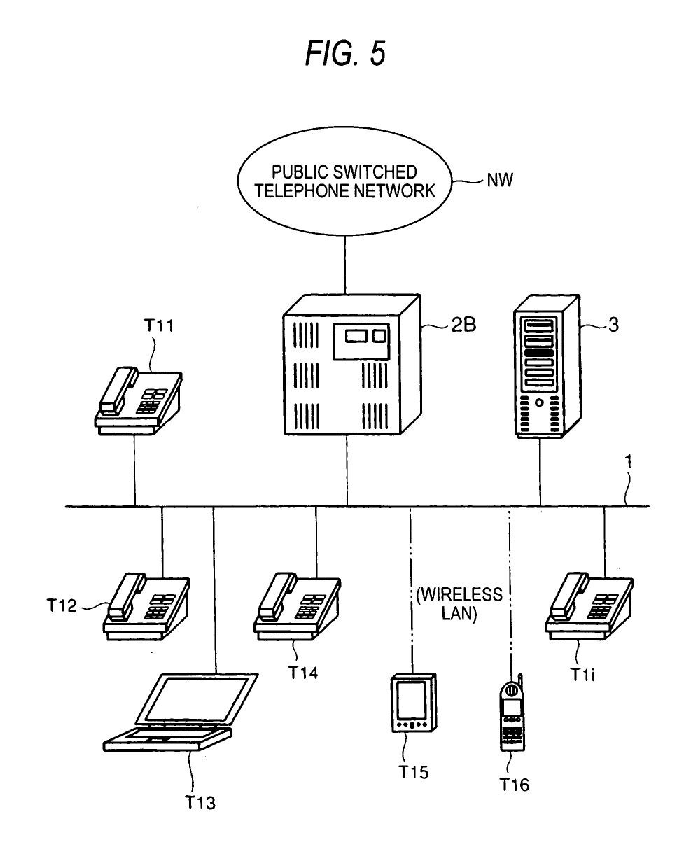

FIG. 5 is a drawing to show the schematic configuration of a network telephone system according to a second embodiment.

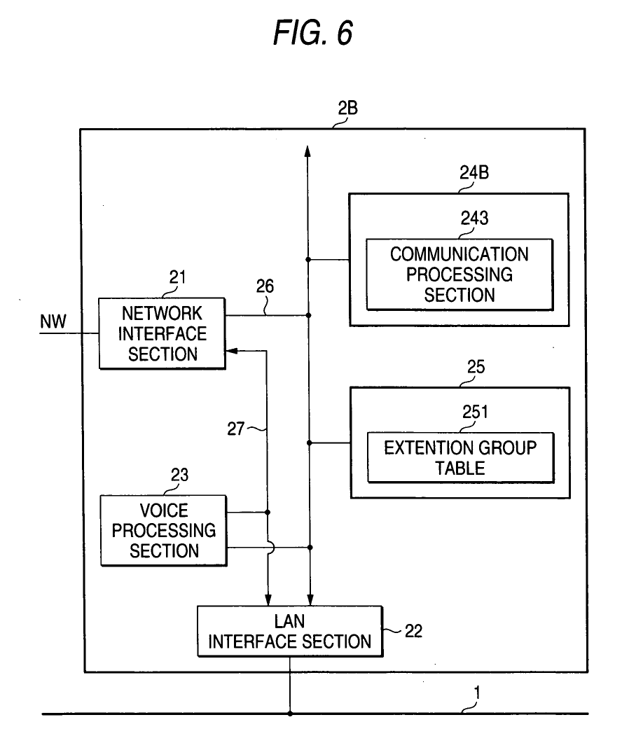

In the network telephone system, a distribution server 3 for executing some of the functions of a gateway 2B is connected to a LAN 1. At this time, the gateway 2B has a functional configuration shown in FIG. 6.

In the gateway 2B, a control section 24B includes a communication processing section 243.

When an incoming call to an extension group (TG1, TG2) comes, the communication processing section 243 communicates control information to and from the distribution server 3 through the LAN 1, and performs incoming control for the corresponding extension group TG1 or TG2 in accordance with the communications. At this time, the communication processing section 243 reads identification information indicating telephone terminals T11, T12, and T13 of the extension group TG1 from an extension group table 251 and transmits the identification information to the distribution server 3.

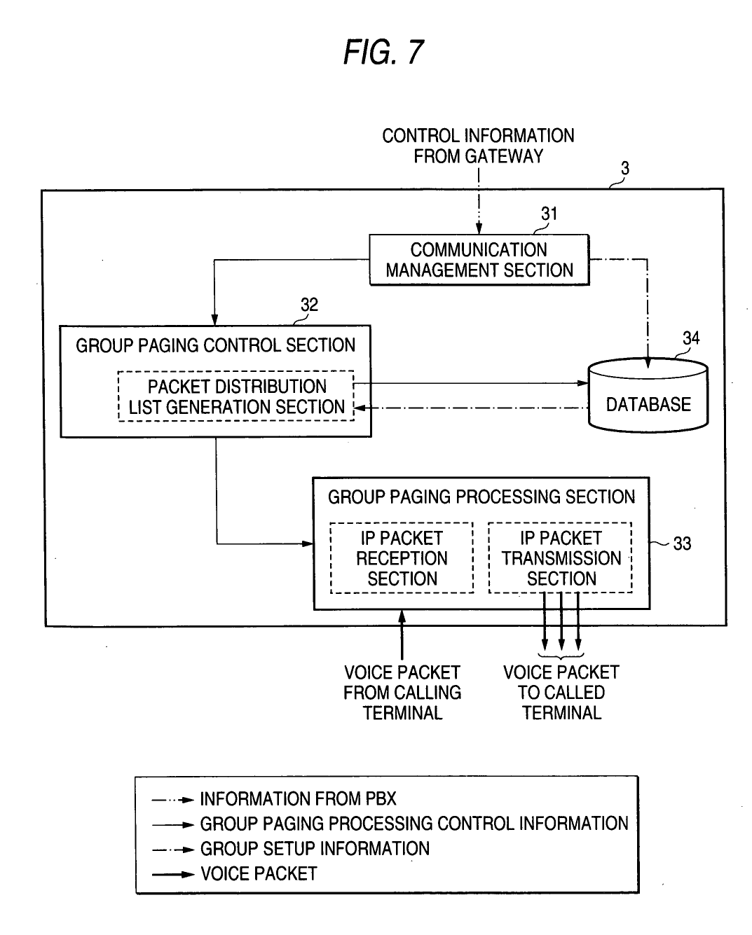

FIG. 7 is a block diagram to show the functional configuration of the distribution server 3.

That is, the distribution server 3 includes a communication management section 31, a group paging control section 32, a group paging processing section 33, and a database 34.

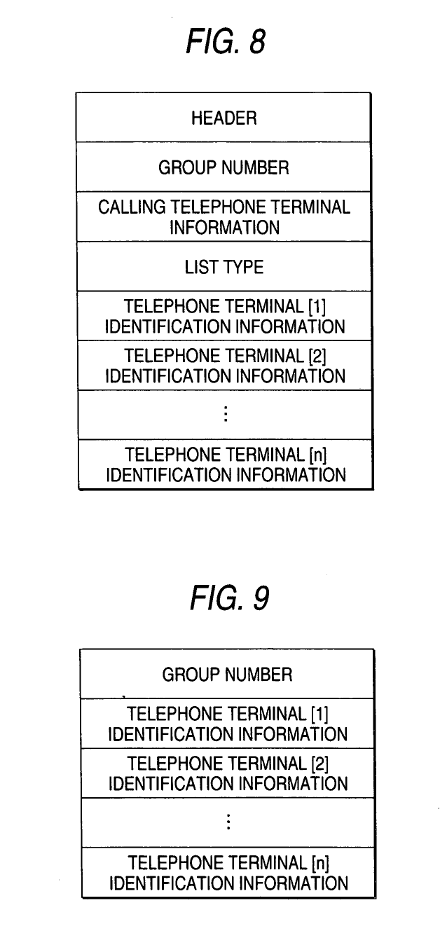

When a group paging request signal for the extension group as shown in FIG. 8 comes from the gateway 2B, the communication management section 31 determines whether or not the group paging start is indicated from header information added to the request signal. When the group paging start is indicated, the communication management section 31 extracts group setup information shown in FIG. 9 from the request signal and registers the group setup information in the database 34. At this time, the communication management section 31 notifies the group paging control section 32 that the group paging start is indicated.

Upon reception of the group paging start information, the group paging control section 32 controls the group paging processing section 33 so as to connect the calling terminal and the called telephone terminal T11, T12, T13 in the extension group TG1 based on the group setup information registered in the database 34.

Upon reception of the connection command, the group paging processing section 33 connects the calling terminal and the called telephone terminal T11, T12, T13 in the extension group TG1 under the control of the group paging control section 32 and distributes the IP packet sent from the calling terminal to the telephone terminals T11, T12, and T13.

The operation of the described system is described below.

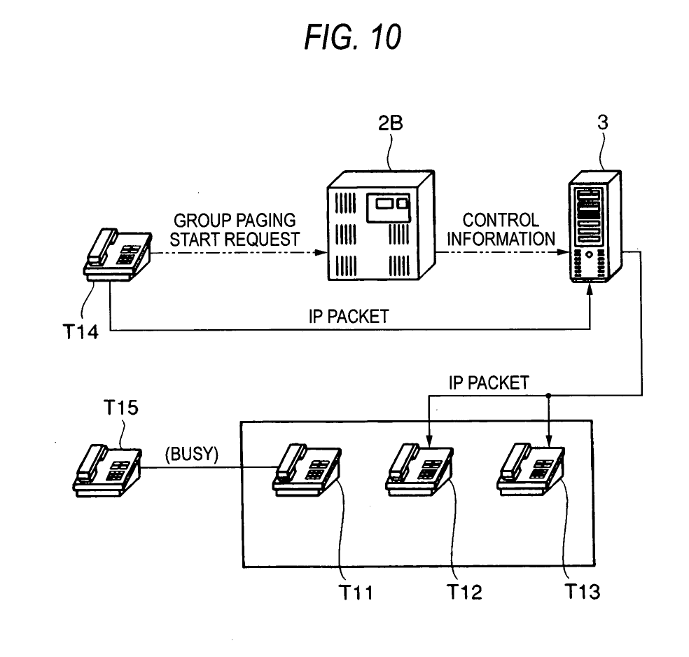

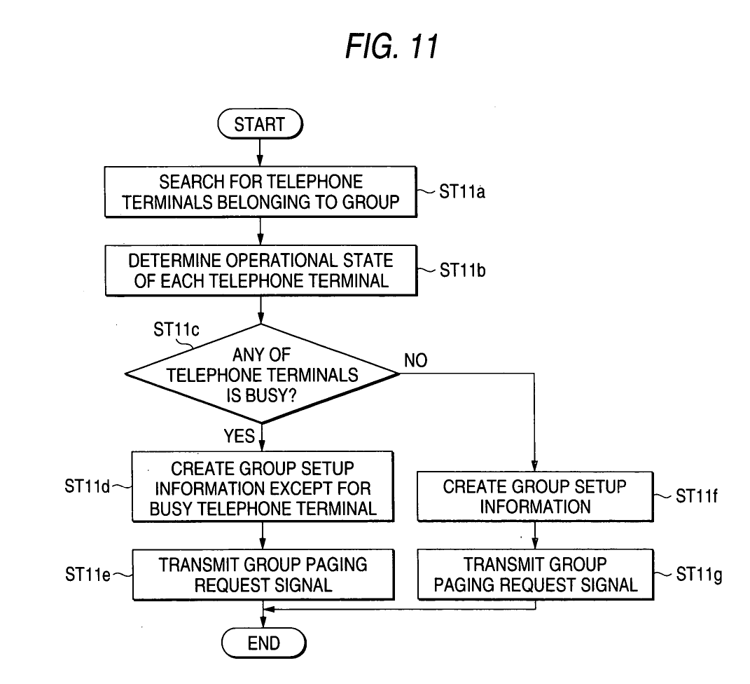

Now, assume that a telephone terminal T14 makes a group paging request for the extension group TG1 and a group paging request signal arrives at the gateway 2B, as shown in FIG. 10. Then, the gateway 2B executes control processing as shown in FIG. 11.

In the gateway 2B, the control section 24B searches the extension group table 251 for the telephone terminals T11, T12, and T13 belonging to the extension group TG1 (step ST11a), determines the operational state of each of the telephone terminals T11, T12, and T13 (step ST11b), and determines whether or not each telephone terminal is busy (ST11c).

At this time, assume that the telephone terminal T11 is busy with a telephone terminal T15. Then, the control section 24B creates group setup information except for the busy telephone terminal T11 (step ST11d) and transmits a group paging request signal containing the group setup information to the distribution server 3 (step ST11e).

On the other hand, if the telephone terminals T11, T12, and T13 are all idle (NO at ST11c), the control section 24B creates group setup information containing the telephone terminals T11, T12, and T13 (step ST11f) and transmits a group paging request signal containing the group setup information to the distribution server 3 (step ST11g).

When the telephone terminal T12 is busy (calling or being called), the control section 24B creates group setup information except for the busy telephone terminal T12.

Upon reception of the group paging request signal, the distribution server 3 forms a communication path between the telephone terminal T14 and the telephone terminal T12, T13 based on the group setup information contained in the group paging request signal, and transfers the IP packet sent from the telephone terminal T14 to the telephone terminals T12 and T13. At this time, the IP packet is sent to the telephone terminals T12 and T13 in a time-division manner.

As described above, in the second embodiment, for example, to execute exchange service control involving processing of the group paging function, it is made possible to share the processing of the group paging function between the distribution server 3 and the gateway 2B for execution, so that the gateway 2B and the distribution server 3 can execute the exchange service control involving the processing of the group paging function in cooperation with each other.

According to the second embodiment described above, the gateway 2B determines the operational state of each of the telephone terminals T11, T12, and T13 belonging to the extension group TG1 prior to the distribution processing of the IP packet and distributes the IP packet only to the idle telephone terminals T12 and T13. Therefore, to share the LAN 1 by a number of telephone terminals T11, T12, T13, and T14, the use efficiency can be enhanced.

### Third Embodiment

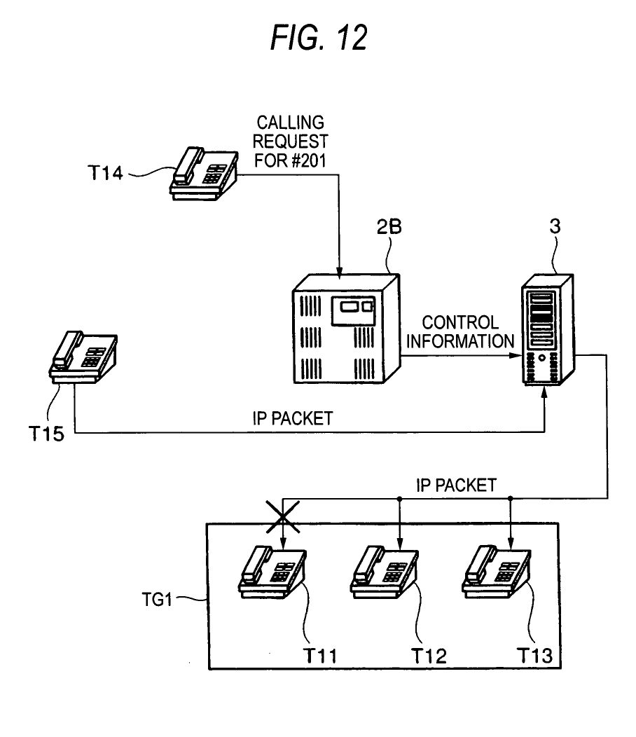

FIG. 12 is a sequence chart to show the distribution operation of an IP packet in a third embodiment. Parts identical with those previously described with reference to FIG. 10 are denoted by the same reference numerals in FIG. 12 and will not be discussed again in detail.

Now, assume that a group paging function is executed between telephone terminals T15 and T11, T12, T13.

In this state, assume that an incoming signal specifying the telephone terminal T11 from a telephone terminal T14 arrives at a gateway 2B. Then, the gateway 2B includes information indicating an extension group TG1 and information indicating the telephone terminal T11 in control information representing group paging processing stop and transmits the control information to a distribution server 3.

Upon reception of the control information, the distribution server 3 releases the communication path between the telephone terminals T11 and T15 and stops distribution of the IP packet. After this, the gateway 2B transfers incoming data to the telephone terminal T11 for making an incoming call notification. When the user of the telephone terminal T11 responds to the incoming call notification, the gateway 2B forms a communication path between the telephone terminals T14 and T11.

As described above, in the third embodiment, when an incoming signal specifying the telephone terminal T11 belonging to the extension group TG1 arrives at the gateway 2B during execution of the group paging function for the extension group TG1, the telephone terminal T11 is excluded from the extension group TG1 and the distribution processing of the IP packet is continued.

Therefore, the group paging function does not occupy all telephone terminals T11, T12, and T13 in the extension group TG1 and if an emergency incoming call specifying one telephone terminal (in this case, T11) in the extension group TG1 comes, the telephone terminal T11 can be connected to the calling telephone terminal T14 preferentially, so that elaborate service can be provided.

### Miscellaneous Embodiments

The present invention is not limited to the specific embodiments described above. For example, the group paging function response to the operational state of each telephone terminal as in the second embodiment may be applied to the first embodiment. In the first embodiment, when an incoming call to one telephone terminal in the extension group comes during execution of the group paging function, the telephone terminal may be excluded from the extension group.

In the third embodiment, when the terminal list in the group setup information transmitted from the gateway to the distribution server does not contain any entries during execution of the group paging function, the distribution server can also stop IP packet distribution processing to all telephone terminals belonging to the group specified in the control information.

As described in detail with reference to the embodiments, when an incoming call for the extension group comes, the group table is referenced and incoming control can be performed for the extension group and it is also made possible to distribute the IP packet of the calling party to the extension group through the communication network by software processing. Thus, it becomes unnecessary to provide not only an additional time switch, but also as many voice signal—IP packet conversion facilities as the number of terminals to which the IP packet (voice signal) is distributed, so that the processing load on the telephone exchange can be decreased.

According to the embodiments, the operational state of each of the telephone terminals belonging to the extension group can be checked prior to the distribution processing of the voice packet and the voice packet is distributed only to the idle telephone terminals, so that to share the communication network by a number of telephone terminals, the use efficiency can be enhanced.

According to the embodiments, when an incoming call specifying one of the telephone terminals belonging to the extension group occurs during transfer of the voice packet to the extension group, the telephone terminal can be excluded from the extension group for performing the distribution processing of the voice packet. Thus, the group paging function does not occupy all telephone terminals in the extension group and if an emergency incoming call specifying one telephone terminal in the extension group comes from a customer, the telephone terminal can be connected to the calling terminal preferentially, so that elaborate service can be provided.

According to the embodiments, for example, to execute exchange service control involving processing of the group paging function, it is made possible to share the processing of the group paging function between the server and the telephone exchange for execution, so that the telephone exchange and the server can execute the exchange service control involving the processing of the group paging function in cooperation with each other.

As described above in detail, there is provided the telephone exchange and the network telephone system that provides the group paging function effectively regardless of the number of terminals to which a voice packet is to be distributed.

It is to be understood that various modifications and changes of the system configuration and type, the configuration of the gateway, the configuration of the distribution server, the execution procedure of the group paging function, etc., may be made without departing from the spirit and the scope of the invention.

The foregoing description of the embodiments of the invention has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A telephone exchange that connects a plurality of telephone terminals through a communication network that transmits voice packet, and allows the plurality of telephone terminals to communicate with each other, the telephone exchange comprising:
a storage unit that stores a group table representing a correspondence between a plurality of extension groups into which the telephone terminals are classified and the telephone terminals belonging to the extension groups;
a controller that, when a connection request to one of the extension groups occurs, refers to the group table and performs connection control for the telephone terminals in the corresponding extension group; and
a transfer unit that transfers voice packets sent from the requester to all of the telephone terminals that belongs to the corresponding extension group through the communication network.

2. The telephone exchange according to claim 1, wherein the controller refers to the group table, determines an operational state of each of the telephone terminals belonging to the corresponding extension group, and performs connection control for idle telephone terminals.

3. The telephone exchange according to claim 1, wherein when a connection request specifying one of the telephone terminals in the corresponding extension group occurs from any other telephone terminal during transfer of the voice packets to all telephone terminals belonging to the corresponding extension group, the transfer unit stops transferring of the voice packets to the specified telephone terminal.

4. A network telephone system comprising:
a telephone exchange that connects a plurality of telephone terminals through a communication network that transmits voice packet, and allows the plurality of telephone terminals to communicate with each other; and
a server that is connected to the communication network,
wherein the terminal exchange includes:
a storage unit that stores a group table representing a correspondence between a plurality of extension groups into which the telephone terminals are classified and the telephone terminals belonging to the extension groups; and
a transfer unit that, when a connection request to one of the extension groups occurs, refers to the group table and transfers information representing the corresponding extension group to the server,
wherein the server includes:
a controller that performs connection control for the telephone terminals in the corresponding extension group based on the information representing the corresponding extension group sent from the telephone exchange; and
a distribution unit that distributes voice packets sent from the requester to all of the telephone terminals that belongs to the corresponding extension group through the communication network.

5. The network telephone system according to claim 4, wherein the controller determines an operational state of each of the telephone terminals belonging to the corresponding extension group based on the information representing the corresponding extension group, and performs connection control for idle telephone terminals.

6. The network telephone system according to claim 4, wherein when a connection request specifying one of the telephone terminals in the corresponding extension group occurs from any other telephone terminal during distribution of the voice packets to all telephone terminals belonging to the corresponding extension group, the distribution unit stops distributing of the voice packets to the specified telephone terminal.

7. A telephone exchange that connects a plurality of telephone terminals through a communication network that transmits voice packet, and allows the plurality of telephone terminals to communicate with each other, the telephone exchange comprising:
a storage means for storing a group table representing a correspondence between a plurality of extension groups into which the telephone terminals are classified and the telephone terminals belonging to the extension groups;
a control means for, when a connection request to one of the extension groups occurs, referring to the group table and performing connection control for the telephone terminals in the corresponding extension group; and
a transfer means for transferring voice packets sent from the requester to all of the telephone terminals that belongs to the corresponding extension group through the communication network.
